(19) United States
(12) Patent Application Publication
(10) Pub. No.: US 2005/0111690 A1
(43) Pub. Date: May 26, 2005

(54) Speaker apparatus

(75) Inventors: Tetsuya Onuma, Yamagata (JP); Koji Maekawa, Yamagata (JP)

Correspondence Address: SUGHRUE MION, PLLC, 2100 PENNSYLVANIA AVENUE, N.W., SUITE 800, WASHINGTON, DC, 20037, US

(73) Assignees: PIONEER CORPORATION; TOHOKU PIONEER CORPORATION

(21) Appl. No.: 10/988,497

(22) Filed: Nov. 16, 2004

(30) Foreign Application Priority Data
Nov. 21, 2003 (JP) P2003-391904

(51) Int. Cl. H04R 1/00; H04R 9/06

(52) U.S. Cl. 381/424; 381/407; 381/423

(57) ABSTRACT

It is to consolidate the connecting structure of a vibration system of a speaker apparatus. A first diaphragm and a voice coil bobbin are connected by a connecting member. A second diaphragm attached to the first diaphragm is attached to the connecting member. Alternatively, reinforcing member is attached to the first diaphragm and the connecting member.

### BACKGROUND OF THE INVENTION

1. Field of the Invention

The present invention relates to a speaker apparatus.

2. Description of the Related Art

There has been proposed a conventional speaker apparatus in which a voice coil bobbin, a diaphragm and a damper are fixed by a connecting member at predetermined places with adhesive agents or the like (refer to JP-A-2002-51394 and JP-A-2002-271893, for example).

### SUMMARY OF THE INVENTION

Although a diaphragm, a voice coil bobbin, and a damper are connected by a connecting member, the connection thereamong is insufficient, so that strength of the connection is deficient. Thus, as an example of a problem of the conventional speaker, it has been cited that a reliable reproduction of a sound pressure is not achieved when a speaker apparatus is driven.

Further, as examples of the problem, there have been cited problems that the connection portions thereamong are liable to change with a lapse of time, and that during the speaker apparatus is driven, a peeling of such components is liable to occur.

According to one aspect of the invention, there is provided a speaker apparatus including: a voice coil bobbin to be inserted in a magnetic gap of a magnetic circuit; a first diaphragm; a connecting member that connects the voice coil bobbin and the first diaphragm; and a second diaphragm disposed in such a way as to cover the voice coil bobbin and the connecting member, and attached to the first diaphragm and to the connecting member.

According to another aspect of the invention, there is provided a speaker apparatus including: a voice coil bobbin to be inserted in a magnetic gap of a magnetic circuit; a first diaphragm; a connecting member that connects the voice coil bobbin and the first diaphragm; a second diaphragm disposed in such a way as to cover the voice coil bobbin and the connecting member, and attached to the first diaphragm; and a reinforcing member disposed between the first diaphragm and the connecting member.

### BRIEF DESCRIPTION OF THE DRAWING

These and other objects and advantages of this invention will become more fully apparent from the following detailed description taken with the accompanying drawings in which:

FIG. 1 is a half-sectional view showing an example of a speaker apparatus applied to an embodiment of the invention;

FIG. 2 is an enlarged sectional view showing an essential part shown in FIG. 1;

FIG. 3 is an enlarged sectional view showing an essential part of a speaker apparatus according to an embodiment of the invention;

FIG. 4 is an enlarged sectional view showing a essential part of a speaker apparatus according to another embodiment of the invention; and

FIG. 5 is an enlarged sectional view showing an essential part of a speaker apparatus according to another embodiment of the invention.

### DETAILED DESCRIPTION OF THE PREFERRED EMBODIMENTS

First, a configuration of a speaker apparatus, which is applied to embodiments of the invention, is described hereinafter.

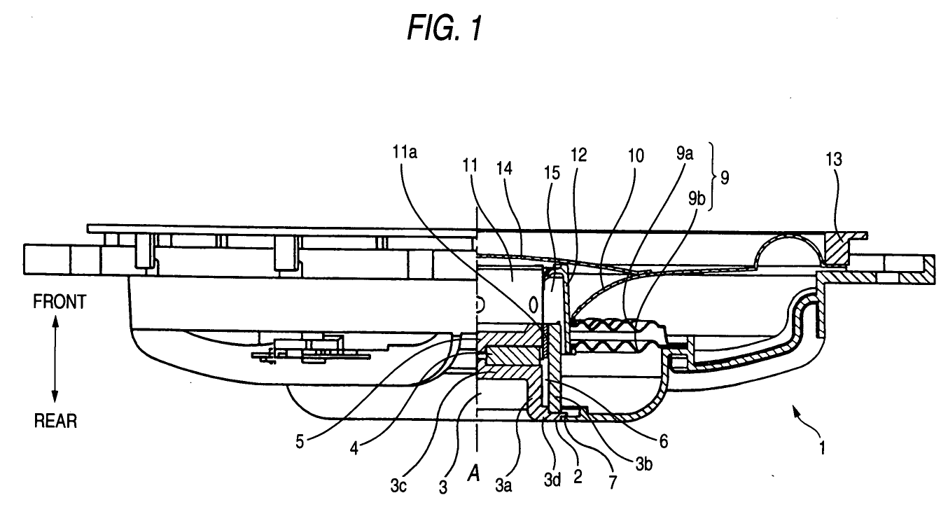

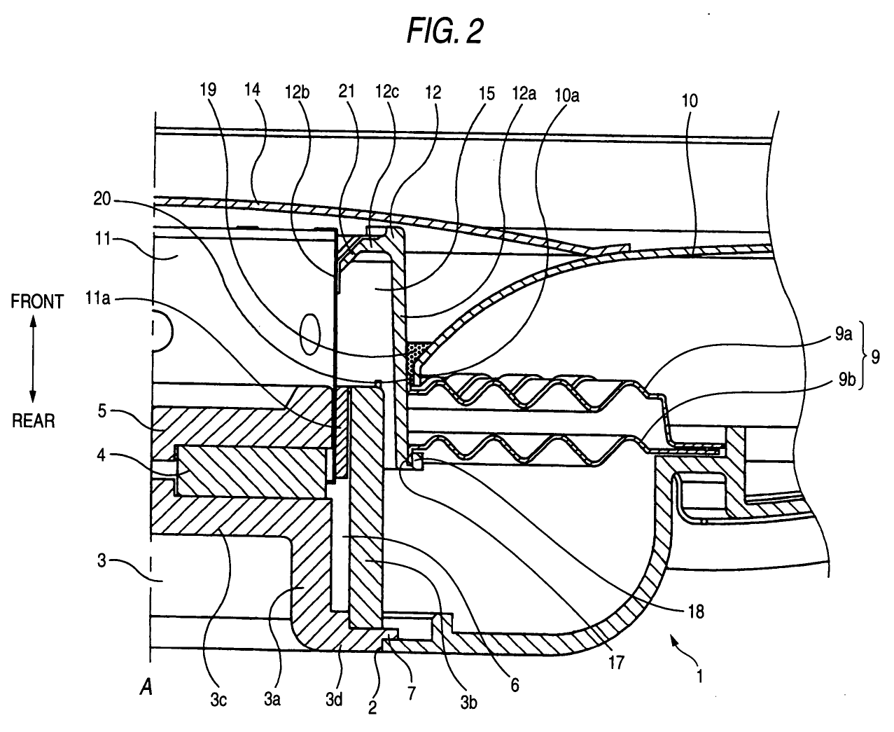

As shown in FIGS. 1 and 2, in this speaker apparatus, a magnetic circuit system portion is accommodated in a concave part of a frame 1, together with a vibration system portion.

The frame 1 is formed nearly like a bowl as a whole, and provided with a fitting hole 2 for fixing the magnetic circuit system portion, in a bottom portion thereof, through which an axis A passes. The frame 1 is formed of a plastic material for weight saving and so on, and may be formed of another material, such as metal.

The magnetic circuit system portion has a yoke 3, a magnet 4, a plate 5, and so on. The yoke 3, the magnet 4 and the plate 5 are stacked in this order in a direction from the rear side of the frame 1 to the front side of the frame 1, that is, an upward direction from the bottom of the concave part of the frame 1, which coincides with that of the axis A, and fixed to the frame 1. In this way, the magnetic circuit system portion including the yoke 3 and so forth is accommodated in the concave part of the frame 1. Thus, the entire speaker apparatus is made to be thin.

As shown in FIGS. 1 and 2, the yoke 3 has double cylindrical portions, which has an inner cylindrical portion 3a and an outer cylindrical portion 3b, and an end plate 3c, which closes the top of the inner cylindrical portion 3a. The bottoms of the inner cylindrical portion 3a and the outer cylindrical portion 3b are connected to each other by an annular bottom plate 3d. The magnet 4 and the plate 5, both of which are shaped like a disk, are stacked on and fixed on the end plate 3c. Outer peripheral surfaces of the inner cylindrical portion 3a of the yoke 3, the magnet 4 and the plate 5 face the inner peripheral surface of the outer cylindrical portion 3b of the yoke 3 across an annular gap 6. Consequently, magnetism is formed in the annular gap 6 between the outer cylindrical portion 3b of the yoke 3 and each of the inner cylindrical portion 3a of the yoke 3, the magnet 4 and the plate 5.

As shown in FIG. 2, the bottom plate 3d of the yoke 3 is formed in such a way as to be fitted into the fitting hole 2 of the frame 1. The yoke 3 is fitted into the fitting hole 2 of the frame 1, so that the speaker apparatus can be made to be thin. This fitting hole 2 can be omitted as occasion arises.

As shown in FIG. 1, the vibration system portion has a damper 9, a first cone-shaped diaphragm 10, a voice coil bobbin 11, a connecting member 12, a second dome-shaped diaphragm 14, and so forth.

As shown in FIG. 2, the damper 9 is used for supporting the vibration system portion on the frame 1, and constituted by combining a first damper part 9a and a second damper part 9b with each other as two layers. The outer peripheral edges of both the damper parts 9a and 9b are fixed in a stacked state to a position at about middle depth of the concave part of the frame 1 by an adhesive agent or the like. The inner peripheral edges of both the damper parts 9a and 9b are separately fixed to the connecting member 12 by an adhesive agent or the like. One of the first damper part 9a and the second damper part 9b may be omitted. Further, a third damper portion, a fourth damper portion, and so on may be provided.

As shown in FIGS. 1 and 2, the first diaphragm 10 has an opening in a central portion thereof, and is disposed at an inlet side in the concave part of the frame 1. The inner peripheral edge of the opening of the first diaphragm 10 is connected to the connecting member 12 by an adhesive agent (not shown) together with the inner peripheral edge of the first damper part serving as an upper layer. The outer peripheral edge of the first diaphragm 10 is fixed by a packing 13 shown in FIG. 1 along the outer periphery of the concave part of the frame 1. Further, the central portion of the first diaphragm 10 is shielded with a second diaphragm 14. The second diaphragm 14 is attached to a predetermined place on the first diaphragm 10 in such a manner as to cover the voice coil bobbin 11 and the connecting member 12.

As shown in FIG. 2, the voice coil bobbin 11 is a cylindrical element to be inserted into a magnetic gap (the annular gap) 6 in the yoke 3 of the magnetic circuit system portion. A voice coil 11a is placed in a lower part of this cylindrical element inserted into the magnetic gap 6. An electric signal flows in the voice coil 11a, so that the voice coil bobbin 11 vibrates on the axis A of the frame 1 under the action of lines of magnetic force (magnetic field).

As shown in FIG. 2, the connecting member 12 is provided in order to connect the damper 9, the first diaphragm 10 and the voice coil bobbin 11, and has an annular groove 15 in which the outer cylindrical portion 3b serving as the cylindrical portion of the yoke 3 is inserted. When the voice coil bobbin 11 vibrates and performs linear reciprocating motions in the front-rear direction of the frame 1 in the annular gap 6 of the yoke 3, the outer cylindrical portion 3b of the yoke 3 performs relative linear reciprocating motions in the annular groove 15 of the connecting member 12.

As shown in FIG. 2, the connecting member 12 has a substantially cylindrical skirt portion 12a to which the damper 9 and the first diaphragm 10 are connected, a substantially cylindrical pendent wall 12b connected to the voice coil bobbin 11 and placed inside the skirt portion 12a, and a ring-like top wall 12c for connecting the tops of the skirt portion 12a and the pendent wall 12b. The annual groove 15 is formed between the skirt portion 12a and the pendent wall 12b.

As shown in FIG. 2, a substantially-U-shaped annular groove 17 opened upwardly, that is, to the front side of the frame 1 is formed at a place touching the second damper part 9b serving as the lower layer in the skirt portion 12a. A bend piece 18 bending downwardly, that is, to the rear side of the frame 1 is formed on the inner peripheral edge of the second damper part 9b. This bend piece 18 enters the upward annular groove 17 of the skirt portion 12a. The second damper portion 9b is rigidly connected to the connecting member 12 by an adhesive agent (not shown) poured into and stored in the annular groove 17.

As shown in FIG. 2, an adhesive agent 19 is also filled and stored in a place at which the first damper part 9a serving as the upper layer in the skirt portion 12a is in contact with the first diaphragm 10.

That is, a bend piece 20 bending upwardly, that is, to the front side of the frame 1 and touching the skirt portion 12a, is formed on the inner peripheral edge of the first damper part 9a. A bend piece 10a bending downwardly, that is, to the rear side of the frame 1 in such a way as to surround the inner peripheral edge of the second damper part 9b, is formed on the inner peripheral edge of the first diaphragm 10. A substantially-V-shaped-cross-sectional annular groove is formed by three elements, which are the bend pieces 20 and 10a and the skirt portion 12a.

Consequently, the first damper part 9a and the first diaphragm 10 are rigidly connected to the skirt portion 12a.

As shown in FIG. 2, an inclined surface 21 inclined to the rear side of the frame 1 is formed on the boundary between the pendent wall 12b and the top wall 12c, which is a place touching the voice coil bobbin 11 of the connecting member 12. A substantially-V-shaped-cross-sectional groove is annularly formed between the inclined surface 21 and the voice coil bobbin 11. An adhesive agent for connecting the voice coil bobbin 11 to the connecting member 12 is poured into and filled in the annular groove.

Hereinafter, embodiments of the invention are described.

### First Embodiment

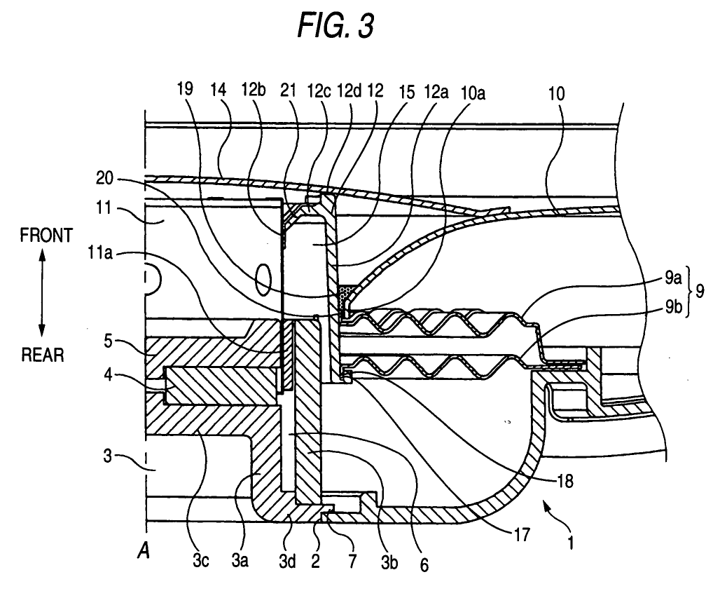

As shown in FIG. 3, an annular curved surface portion 12d, whose curvature is close to that of a the second diaphragm 14, is provided at an upper part of a continuously connecting portion between the top wall 12c and the skirt portion 12a of the connecting member 12. The second diaphragm 14 is fixed to the connecting portion 12 by applying an adhesive agent to a part of the inner surface (the surface at the side of the connecting member 12) of the second diaphragm 14, which faces the curved surface portion 12d.

According to such a first embodiment, both the second diaphragm 14 and the first diaphragm 10 are fixed to the connecting member 12. Thus, the connection among constituents of the vibration system mainly configured with the voice coil bobbin 11, the first diaphragm 10, and the second diaphragm 14 is consolidated. Consequently, the transmission of vibrations is reliably achieved. More accurate reproduction of sound pressure is achieved. Also, divided vibration generated in the first diaphragm 10 can be reduced. Acoustic characteristics of the speaker apparatus can be enhanced.

Also, a structure connecting joint portions among the first diaphragm 10, the connecting member 12 and the second diaphragm 14 is shaped substantially like a triangle. The connecting strength thereamong is further increased by establishing such a substantially triangular structure.

### Second Embodiment

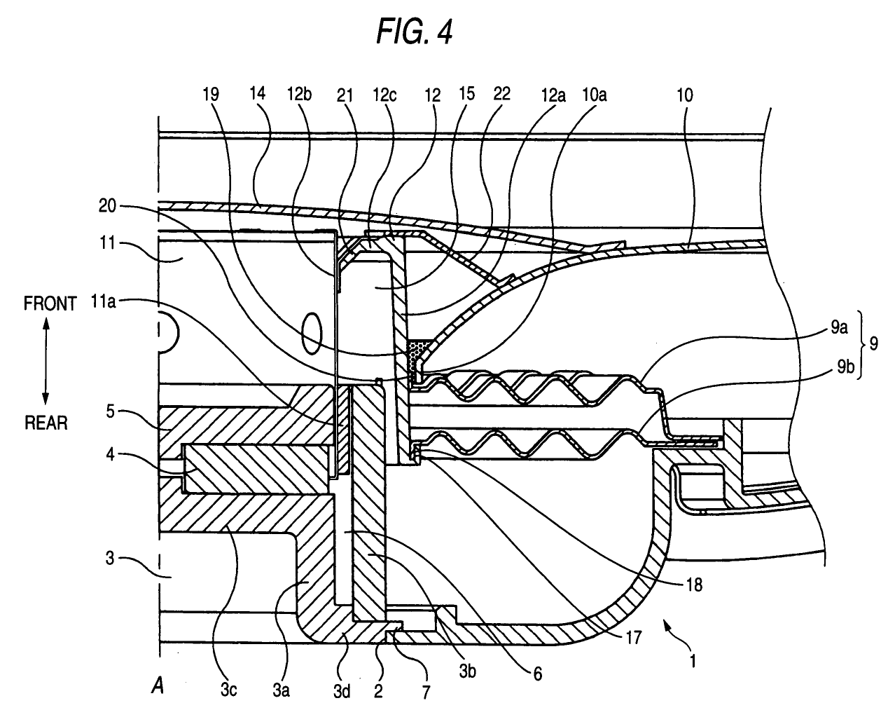

As shown in FIG. 4, both ends of an annular element 22 serving as a reinforcing member are placed between an upper part of a continuously connecting portion, which is provided between the top wall 12c and the skirt portion 12a of the connecting member 12, and a middle portion of the first diaphragm 10. The top of the annular element 22 is fixed to the upper part of the continuously connecting portion by an adhesive agent, while the bottom of the annular element 22 is fixed to the middle portion of the first diaphragm 10 by an adhesive agent. The bottom of the annular element 22 is attached to a part between a predetermined place, to which the second diaphragm 14 is attached, and a place, to which the skirt portion 12a of the connecting member 12 is connected, in the first diaphragm 10. For example, hard and light annular paper, a thin and hard plastic annular element, and a light and hard metallic annular element may be used as the annular element 22.

According to such a second embodiment, the connection between the first diaphragm 10 and the connecting member 12 is reinforced by the annular element 22. Thus, the structure and the connection among constituents of the vibration system mainly configured with the voice coil bobbin 11, the first diaphragm 10 and the second diaphragm 14 are consolidated. Consequently, the transmission of vibrations is reliably achieved. More accurate reproduction of sound pressure is achieved. Also, divided vibration generated in the first diaphragm 10 can be reduced. Acoustic characteristics of the speaker apparatus can be enhanced.

Also, a structure connecting joint portions, at which the first diaphragm 10, the connecting member 12 and the annular element 22 are mutually connected, is shaped substantially like a triangle. The connecting strength thereamong is further increased by establishing such a substantially triangular structure.

Incidentally, the top of the annular element 22 may be connected to a predetermined part of a side surface of the skirt portion 12a of the connecting member 12.

### Third Embodiment

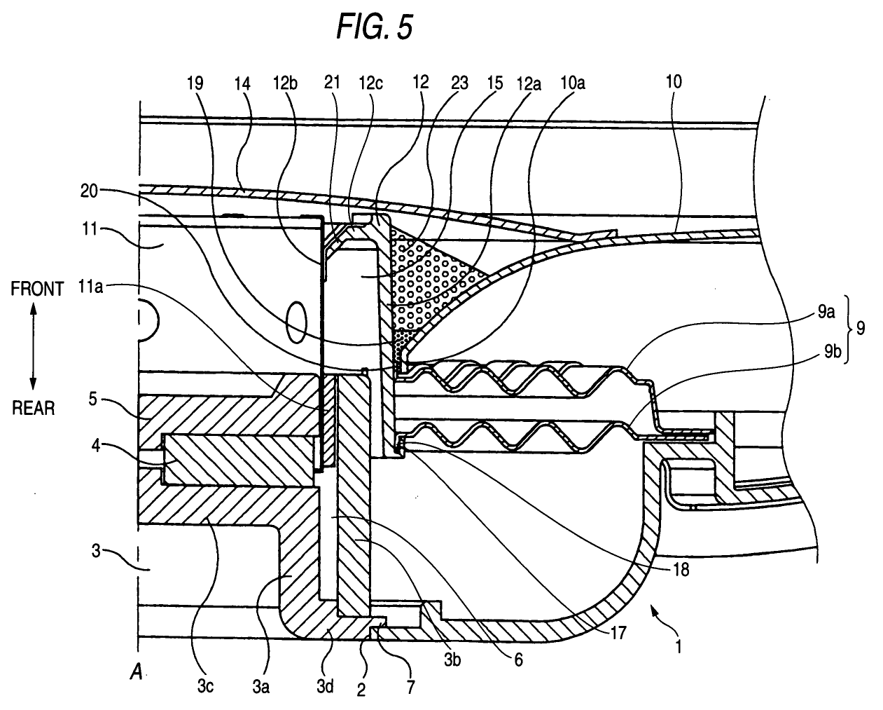

As shown in FIG. 5, an annular surface-connecting element (reinforcing member) 23 is disposed in a space between the skirt portion 12a of the connecting member 12 and the first diaphragm 10. A surface of the surface-connecting element 23 is surface-connected to the first diaphragm 10 and fixed thereto by an adhesive agent. The other surface of the surface-connecting element 23 is surface-connected to a side surface of the skirt portion 12a and fixed thereto by an adhesive agent. A cross-section of the surface-connecting element 23, which extends along a radial direction of the first diaphragm 10, is shaped substantially like a triangle. Further, the material of the surface-connecting element 23 is configured with, for instance, a light resin foam.

According to a third embodiment, the connection between the first diaphragm 10 and the connecting member 12 is reinforced by the surface-connecting element 23. Thus, the structure and the connection among constituents of the vibration system mainly configured with the voice coil bobbin 11, the first diaphragm 10 and the second diaphragm 14 are consolidated. Consequently, the transmission of vibrations is reliably achieved. More accurate reproduction of sound pressure is achieved. Also, divided vibration generated in the first diaphragm 10 can be reduced. Acoustic characteristics of the speaker apparatus can be enhanced.

Further, the surface-connecting element 23 is configured as a structure, whose radial cross-section is shaped substantially like a triangle. Thus, the connecting strength is further increased.

Also, the connection area between the surface-connecting element 23 and each of the connecting member 12 and the first diaphragm 10 is broad, so that the connection therebetween becomes reliable.

### Fourth Embodiment

Although the second diaphragm 14 and the connecting member 12 are not directly physically connected to each other in each of the aforementioned embodiments shown in FIGS. 4 and 5, the second diaphragm 14 is connected to the connecting member 12 in this fourth embodiment. That is, similarly to the embodiment shown in FIG. 3, an annular curved surface portion 12d, whose curvature is close to that of the second diaphragm 14, is provided at an upper part of a continuously connecting portion between the top wall 12c and the skirt portion 12a of the connecting member 12. The second diaphragm 14 is fixed to the connecting portion 12 by applying an adhesive agent to a part of the inner surface of the second diaphragm 14, which faces the curved surface portion 12d.

According to the fourth embodiment, the second diaphragm 14 is fixed to the connecting member 12 together with the first diaphragm 10. Thus, the connection among constituents of the vibration system mainly configured with the voice coil bobbin 11, the first diaphragm 10 and the second diaphragm 14 is further consolidated. The transmission of vibrations is reliably achieved. More accurate reproduction of sound pressure is achieved. Also, divided vibration generated in the first diaphragm 10 can be reduced. Acoustic characteristics of the speaker apparatus can be enhanced.

The foregoing description of preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

1. A speaker apparatus comprising:
a voice coil bobbin to be inserted in a magnetic gap of a magnetic circuit;
a first diaphragm;
a connecting member that connects the voice coil bobbin and the first diaphragm; and
a second diaphragm disposed in such a way as to cover the voice coil bobbin and the connecting member, and attached to the first diaphragm and to the connecting member.

2. A speaker apparatus comprising:
a voice coil bobbin to be inserted in a magnetic gap of a magnetic circuit;
a first diaphragm;
a connecting member that connects the voice coil bobbin and the first diaphragm;
a second diaphragm disposed in such a way as to cover the voice coil bobbin and the connecting member, and attached to the first diaphragm; and
a reinforcing member disposed between the first diaphragm and the connecting member.

3. The speaker apparatus according to claim 2, wherein the reinforcing member is an annular element having one end connected to the connecting member, and the other end connected to the first diaphragm.

4. The speaker apparatus according to claim 2, wherein the reinforcing member is an annular surface-connecting element having one surface connected to the connecting member, and the other surface connected to the first diaphragm.

5. The speaker apparatus according to claim 1, wherein a structure connecting joint portions, at which the first diaphragm, the connecting member and the second diaphragm are mutually connected, is shaped substantially like a triangle.

6. The speaker apparatus according to claim 3, wherein a structure connecting joint portions, at which the first diaphragm, the connecting member and the reinforcing member are mutually connected, is shaped substantially like a triangle.
